(19) United States
(12) Patent Application Publication
(10) Pub. No.: US 2015/0288687 A1
(43) Pub. Date: Oct. 8, 2015

(54) SYSTEMS AND METHODS FOR SENSOR BASED AUTHENTICATION IN WEARABLE DEVICES

(71) Applicant: InvenSense, Incorporated, San Jose, CA (US)

(72) Inventors: Ardalan Heshmati, Saratoga, CA (US); Behrooz Abdi, San Jose, CA (US); Karthik Katingari, Milpitas, CA (US)

(73) Assignee: InvenSense, Incorporated, San Jose, CA (US)

(21) Appl. No.: 14/247,158

(22) Filed: Apr. 7, 2014

(51) Int. Cl. H04L 29/06; G06F 3/01; H04L 29/08

(52) U.S. Cl. CPC H04L 63/0861; H04L 67/10; H04L 63/105; G06F 3/017

(57) ABSTRACT

Systems and methods are disclosed for providing sensor based authentication of a user's identification and may be used to control access. In this manner, a user's identity may be used to control access to any suitable location, space or resource, either locally or remotely. A combination of functions involved in authenticating a user's identification may be performed by one or more discrete devices and include obtaining sensor data from at least one sensor that is physically associated with a user, monitoring to determine that the sensor remains physically associated with the user, authenticating the user's identity using the sensor data and communicating information regarding the user's identification.

### FIELD OF THE PRESENT DISCLOSURE

This disclosure generally relates to utilizing data from a device receiving sensor data and more specifically to authenticating a user's identification using such data.

### BACKGROUND

In many situations, it is desirable to control access to locations or resources to restrict unauthorized use. In one aspect, this may include controlling access to physical locations or objects by providing a locking mechanism that restricts access and a key that interfaces with the mechanism to activate or deactivate the locking mechanism. Numerous examples exist, such as locking doors for controlling access to buildings or specific rooms within a building, locking containers in the form of safes, ignition locks for vehicles and countless others. These locking mechanisms may utilize a mechanical interaction between the key and the locking mechanism or a digital interaction, wherein the “key,” such as a pass card, provides authentication information that may be read by the locking mechanism. Further, the concept of a key may be abstracted to include a piece of information known by a user, such as a password or code combination, which may be entered to gain access, such as by logging on to a computer. In addition to controlling access to locations or objects within the physical vicinity of a user, it is likewise desirable to control access to remote resources, objects or devices, such as a banking application running on a server at a financial institution, a home security system that may be configured or monitored by a vacationing user, or in a wide variety of other applications that will readily be appreciated by one of skill in the art.

Regardless of whether access is controlled through the use of a physical key or an abstract key, these conventional techniques suffer from various limitations. For example, a key may be stolen or otherwise acquired, allowing access to an unauthorized person. Further, a key may be lost or forgotten, preventing an authorized user from gaining access. It may also be difficult to restrict copying of a key, again leading to the potential for an unauthorized access. Still further, given the increasing number of situations in which some form of secured access control is implemented, a user may be required to carry or remember an unwieldy number of keys. Many of these drawbacks could be avoided by providing access control that relies on a user's identity rather than possession or knowledge of a key.

The development of microelectromechanical systems (MEMS) has enabled the incorporation of a wide variety of sensors into mobile devices, such as cell phones, laptops, tablets, gaming devices and other portable, electronic devices. Non-limiting examples of sensors include motion or environmental sensors, such as an accelerometer, a gyroscope, a magnetometer, a pressure sensor, a microphone, a proximity sensor, an ambient light sensor, an infrared sensor, and the like. Further, sensor fusion processing may be performed to combine the data from a plurality of sensors to provide an improved characterization of the device's motion or orientation. These types of sensors have become more and more prevalent in various types of mobile devices that may be carried or worn by a user.

Given the increased availability of sensor data, it would be desirable to provide systems and methods for identifying a user by employing data from one or more sensors. In turn, access control in any suitable context may be predicated on the identification of the user. This disclosure satisfies these and other goals, as will be appreciated in view of the following discussion.

### SUMMARY

As will be described in detail below, this disclosure includes a system for personal identification having a wearable device, a status monitor, an authenticator and an indicator, such that the wearable device includes at least one sensor and may be configured to be physically associated with a user, the status monitor may be configured to determine that the wearable wearable device is physically associated with the user, the authenticator may be configured to identify the user based at least in part on data received from at least one sensor when the status monitor determines the wearable device is physically associated with the user and the indicator may be configured to communicates identification information regarding with the user. The wearable device may be configured to be worn by the user.

In one aspect, the indicator may communicate identification information associated with the user in response to determining from the status monitor that the wearable device has been worn continuously since the user was identified. As desired, the indicator may be a visual cue, an auditory cue and/or a tactile cue. The indicator may also communicate identification information regarding with the user to an external device and/or may communicate over a network.

In one aspect, either or both of the authenticator and indicator may be integrated into the wearable device. The authenticator may also be implemented remotely.

In one aspect, at least one sensor may be a camera and the authenticator may identify the user based at least in part on detecting a distinguishing feature of the user.

In one aspect, at least one sensor may be a microphone and the authenticator may identify the user based at least in part on the user's voice.

In one aspect, at least one sensor may be a heart rate sensor.

In one aspect, at least one sensor may be a motion sensor. As desired, the authenticator may identify the user based at least in part on detecting a gesture and/or a pattern of motion associated with the user.

In one aspect, wherein the authenticator may be configured to identify a plurality of users.

In one aspect, the authenticator identifies the user based at least in part on a geographic location of the wearable device.

In one aspect, the authenticator may be configured to provide different levels of verification when identifying the user.

In one aspect, the authenticator may be configured to provide the user with a security evaluation regarding identification of the user.

This disclosure also includes methods for verifying the identity of a user. A suitable method may involve obtaining data from a wearable device having at least one sensor configured to be physically associated with the user, monitoring whether the wearable device is physically associated with the user, authenticating the user's identification based at least in part on the data if the data was obtained while the wearable device was physically associated with the user and communicating identification information regarding the user. The wearable device may be worn by the user.

In one aspect, identification information regarding the user may be communicated after determining the wearable device has been continuously associated with the user since authentication of the user's identification. Communicating identification information regarding the user may be at least one of a visual cue, an auditory cue and a tactile cue. In a further aspect, identification information regarding the user may be communicated to an external device and/or may be communicated over a network.

In one aspect, at least one sensor may be a camera and the user's identification may be authenticated based at least in part on detecting a distinguishing feature of the user.

In one aspect, at least one sensor may be a microphone and the user's identification may be authenticated based at least in part on the user's voice.

In one aspect, user's identification may be authenticated based at least in part on detecting a gesture and/or a pattern of motion associated with the user.

In one aspect, a plurality of users may be identified.

In one aspect, the user's identification may be authenticated based at least in part on a location of the wearable device.

In one aspect, different levels of verification may be provided when authenticating the user's identification.

In one aspect, the method may include providing the user with a security evaluation regarding authentication of the user's identification.

### BRIEF DESCRIPTION OF THE DRAWINGS

FIG. 1 is schematic diagram of a wearable device for authenticating a user's identification according to an embodiment.

FIG. 2 is a schematic diagram showing a personal identification system according to an embodiment.

FIG. 3 schematically represents authentication of a user based on gesture recognition according to an embodiment.

FIG. 4 schematically represents authentication of a user based on recognition of walking pattern according to an embodiment.

FIG. 5 schematically represents authentication of a user based on facial recognition according to an embodiment.

FIG. 6 is a flowchart showing a routine for authenticating a user's identification according to an embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

In the described embodiments, a chip is defined to include at least one substrate typically formed from a semiconductor material. A single chip may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. MEMS cap provides mechanical support for the MEMS structure. The MEMS structural layer is attached to the MEMS cap. The MEMS cap is also referred to as handle substrate or handle wafer. In the described embodiments, an electronic device incorporating a sensor may employ a motion tracking module also referred to as Motion Processing Unit (MPU) that includes at least one sensor in addition to electronic circuits. The sensor, such as a gyroscope, a compass, a magnetometer, an accelerometer, a microphone, a pressure sensor, a proximity sensor, or an ambient light sensor, among others known in the art, are contemplated. Some embodiments include accelerometer, gyroscope, and magnetometer, which each provide a measurement along three axes that are orthogonal relative to each other referred to as a 9-axis device. Other embodiments may not include all the sensors or may provide measurements along one or more axes. The sensors may be formed on a first substrate. Other embodiments may include solid-state sensors or any other type of sensors. The electronic circuits in the MPU receive measurement outputs from the one or more sensors. In some embodiments, the electronic circuits process the sensor data. The electronic circuits may be implemented on a second silicon substrate. In some embodiments, the first substrate may be vertically stacked, attached and electrically connected to the second substrate in a single semiconductor chip, while in other embodiments, the first substrate may be disposed laterally and electrically connected to the second substrate in a single semiconductor package.

In one embodiment, the first substrate is attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Motion data refers to processed raw data. Processing may include applying a sensor fusion algorithm or applying any other algorithm. In the case of a sensor fusion algorithm, data from one or more sensors may be combined to provide an orientation of the device. In the described embodiments, a MPU may include processors, memory, control logic and sensors among structures.

As indicated above, the techniques of this disclosure are directed to providing sensor based user identification to control access. Although these techniques are described with respect to certain exemplary embodiments, a user's identity may be used to control access to any suitable location, space or resource, either locally or remotely. In one aspect, a combination of functions may be performed by one or more discrete devices, including obtaining sensor data from at least one sensor that is physically associated with a user, monitoring to determine that the sensor remains physically associated with the user, authenticating the user's identity using the sensor data and communicating information regarding the user's identification.

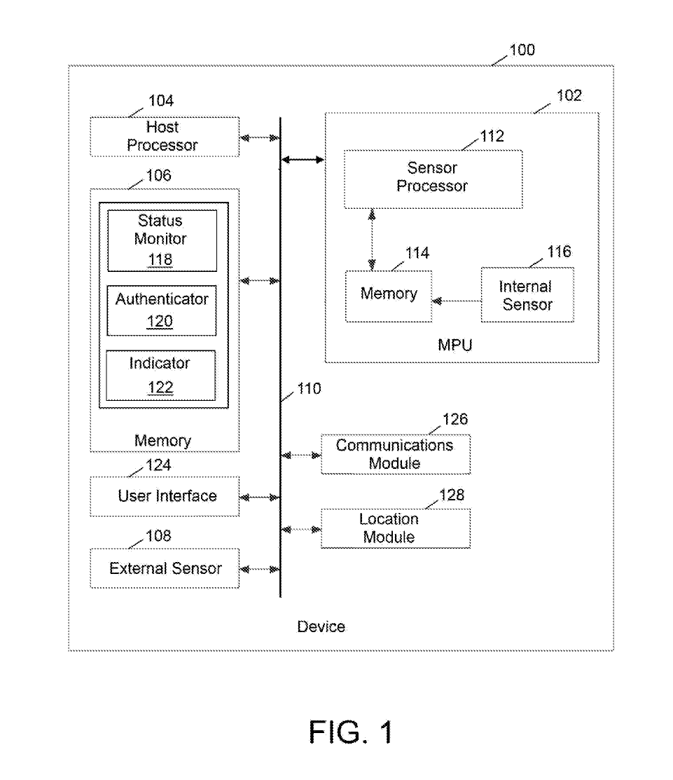

Certain details regarding one embodiment of an identification system exhibiting features of this disclosure in the form of mobile electronic wearable device 100 are depicted as high level schematic blocks in FIG. 1. As will be appreciated, device 100 may be implemented as a device or apparatus that is configured to be worn, such as a watch, wrist band, ring, pedometer, anklet or the like. However, as used herein, the term “wearable device” also includes a device that may be physically associated with a user, such as a handheld device that may be carried by the user or to be used with an accessory that physically associates the device with a user, such as a holster, arm band or similar structures. For example, such a device may be a mobile phone (e.g., cellular phone, a phone running on a local network, or any other telephone handset), personal digital assistant (PDA), tablet, video game player, video game controller, navigation device, mobile internet device (MID), personal navigation device (PND), digital still camera, digital video camera, binoculars, telephoto lens, portable music, video, or media player, remote control, or other handheld device, or a combination of one or more of these devices.

In some embodiments, wearable device 100 may be a self-contained device that includes its own display and sufficient computational and interface resources to provide the functions described above, including obtaining sensor data, monitoring the physical association of the sensor with the user, authenticating the user's identity and communicating the identification information. However, in other embodiments, wearable device 100 may function in conjunction with one or more of a portable device, such as one of those noted above, or a non-portable device such as a desktop computer, electronic tabletop device, server computer, etc., any of which can communicate with wearable device 100, e.g., via wired or wireless network connections. Wearable device 100 may be capable of communicating via a wired connection using any type of wire-based communication protocol (e.g., serial transmissions, parallel transmissions, packet-based data communications), wireless connection (e.g., electromagnetic radiation, infrared radiation or other wireless technology), or a combination of one or more wired connections and one or more wireless connections.

Therefore, depending on the embodiment, wearable device 100 may include at a minimum one or more sensors outputting data that may be used to identify a user that is physically associated with the device. The other functions associated with this disclosure, including monitoring the physical association of the sensor with the user, authenticating the user's identity and communicating the identification information, as well as others, may be implemented either in wearable device 100 or in one or more additional devices as desired and depending on the relative capabilities of the respective devices. As an example, wearable device 100 may be used in conjunction with another device, such as a smart phone or tablet, which may be used to perform any or all of the functions other than outputting sensor data. Any combination of the involved functions may be distributed among as many local and remote devices as desired. For purposes of illustration and not limitation, a first device may have the sensor that is physically associated with the user, a second device may be local and monitor the physical association of the sensor and a third device may be remote and provide the authentication of the user's identity using the sensor data. Thus, as used herein, the term “identification system” means either a self-contained device or a wearable device used in conjunction with one or more additional devices.

In this context, FIG. 1 schematically illustrates an embodiment of device 100 that is self-contained, and includes MPU 102, host processor 104, host memory 106, and external sensor 108. Host processor 104 may be configured to perform the various computations and operations involved with the general function of device 100. Host processor 104 may be coupled to MPU 102 through bus 110, which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, or other equivalent. Host memory 106 may include programs, drivers or other data that utilize information provided by MPU 102. Exemplary details regarding suitable configurations of host processor 104 and MPU 102 may be found in co-pending, commonly owned U.S. patent application Ser. No. 12/106,921, filed Apr. 21, 2008, which is hereby incorporated by reference in its entirety.

In this embodiment, MPU 102 is shown to include sensor processor 112, memory 114 and internal sensor 116. Memory 114 may store algorithms, routines or other instructions for processing data output by sensor 116 or sensor 108 as well as raw data and motion data. Internal sensor 116 may include one or more sensors, such as accelerometers, gyroscopes, magnetometers, pressure sensors, microphones and other sensors. Likewise, external sensor 108 may include one or more sensors, such as accelerometers, gyroscopes, magnetometers, pressure sensors, microphones, cameras, proximity, and ambient light sensors, and temperature sensors among others sensors. As used herein, an internal sensor refers to a sensor implemented using the MEMS techniques described above for integration with an MPU into a single chip. Similarly, an external sensor as used herein refers to a sensor carried on-board the device that is not integrated into a MPU.

In some embodiments, the sensor processor 112 and internal sensor 116 are formed on different chips and in other embodiments; they reside on the same chip. In yet other embodiments, a sensor fusion algorithm that is employed in calculating orientation of device is performed externally to the sensor processor 112 and MPU 102, such as by host processor 104. In still other embodiments, the sensor fusion is performed by MPU 102. More generally, device 100 incorporates MPU 102 as well as host processor 104 and host memory 106 in this embodiment.

As will be appreciated, host processor 104 and/or sensor processor 112 may be one or more microprocessors, central processing units (CPUs), or other processors which run software programs for device 100 or for other applications related to the functionality of device 100. For example, different software application programs such as menu navigation software, games, camera function control, navigation software, and phone or a wide variety of other software and functional interfaces can be provided. In some embodiments, multiple different applications can be provided on a single device 100, and in some of those embodiments, multiple applications can run simultaneously on the device 100. In some embodiments, host processor 104 implements multiple different operating modes on device 100, each mode allowing a different set of applications to be used on the device and a different set of activities to be classified. As used herein, unless otherwise specifically stated, a “set” of items means one item, or any combination of two or more of the items.

Multiple layers of software can be provided on a computer readable medium such as electronic memory or other storage medium such as hard disk, optical disk, flash drive, etc., for use with host processor 104 and sensor processor 112. For example, an operating system layer can be provided for device 100 to control and manage system resources in real time, enable functions of application software and other layers, and interface application programs with other software and functions of device 100. A motion algorithm layer can provide motion algorithms that provide lower-level processing for raw sensor data provided from the motion sensors and other sensors, such as internal sensor 116 and/or external sensor 108. Further, a wearable device driver layer may provide a software interface to the hardware sensors of device 100.

Some or all of these layers can be provided in host memory 106 for access by host processor 104, in memory 114 for access by sensor processor 112, or in any other suitable architecture. For example, in some embodiments, host processor 104 may execute stored instructions in the form of status monitor 118 for determining whether the external sensor 108 and/or internal sensor 116 are physically associated with the user. Further, host processor 104 may additionally execute stored instructions in the form of authenticator 120 to identify the user and in the form of indicator 122 to communicate information regarding the user's identification. These respective functions are described more fully below. In other embodiments, as also described below, other divisions of processing may be apportioned between the sensor processor 112 and host processor 104 as is appropriate for the applications and/or hardware used, where some of the layers (such as lower level software layers) are provided in MPU 102. Alternatively, or in addition, the functions associated with status monitor 118, authenticator 120 and/or indicator 122 may include software code, hardware, firmware or any suitable combination and may be implemented in one or more additional devices. Thus, status monitor 118, authenticator 120 and/or indicator 122 may include, without limitation, application software, firmware, resident software, microcode, etc, such as in the form of a computer program product accessible from a computer-usable or computer-readable medium providing program code for use by or in connection with a computer or any instruction execution system. For the purposes of this description, a computer-usable or computer-readable medium may be any apparatus that can contain, store, communicate, propagate, or transport the program for use by or in connection with the instruction execution system, apparatus, or device.

Device 100 may also include user interface 124 which provides mechanisms for effecting input and/or output to a user, such as a display screen, audio speakers, buttons, switches, a touch screen, a joystick, a trackball, a mouse, a slider, a knob, a printer, a scanner, a camera, or any other similar components. Further, device 100 may include one or more communication modules 126 for establishing a communications link, which may employ any desired wired or wireless protocol, including without limitation WiFi®, cellular-based mobile phone protocols such as long term evolution (LTE), BLUETOOTH®, ZigBee®, ANT, Ethernet, peripheral component interconnect express (PCIe) bus, Inter-Integrated Circuit (I2C) bus, universal serial bus (USB), universal asynchronous receiver/transmitter (UART) serial bus, advanced microcontroller bus architecture (AMBA) interface, serial digital input output (SDIO) bus and the like. As will be described below, communications module 126 may be configured to transmit sensor data and/or identification information regarding a user or to receive an authentication of a user's identity. Communications module 126 may also be used to receive data from a remote sensor that may be used for authenticating a user's identification. Still further, device 100 may include location module 128 such as a global positioning system (GPS), wireless local area network (WLAN) or cellular positioning, or any other suitable source of information regarding the absolute geographical position of wearable device 100 or its relative proximity to a reference location.

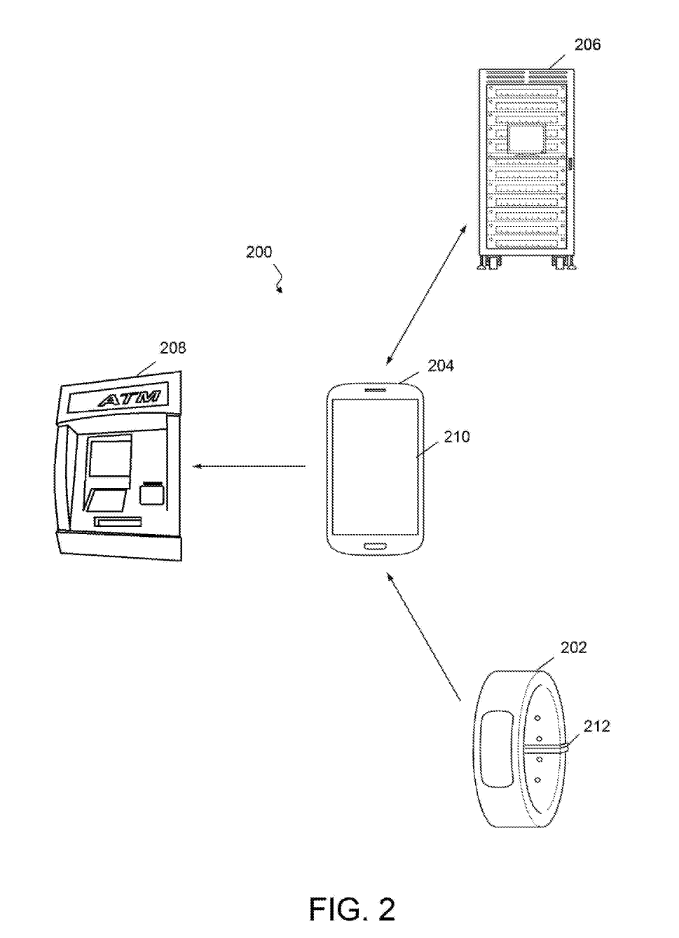

Further details regarding techniques of this disclosure may be described in the context of identification system 200 as shown in FIG. 2. System 200 may include wearable device 202 having at least one sensor for obtaining data that may be used to identify a user. Wearable device 200 may communicate the sensor data to mobile device 204, which in this embodiment may implement the function of monitoring wearable device 202 to determine whether it is physically associated with the user. In one aspect, any data obtained through wearable device 202 that is used to identify a user and/or any identification using that data may be considered valid so long as a status monitor implemented by mobile device 204 determines that the data was obtained while wearable device 202 was physically associated with the user and that wearable device 202 has remained physically associated with the user after authentication of the identification.

Further, system 200 may include a remote server 206 to authenticate a user's identification. As shown, mobile device 204 may relay data from wearable device 202 to server 206. An authenticator implemented by server 206 may compare the relayed data to a stored profile to identify the user. Correspondingly, server 206 may confirm the user's identity to mobile device 204. In turn, mobile device 204 may implement an indicator for communicating information regarding the user's identification. In one aspect, the user may also utilize the authentication information regarding identification stored by remote server 206 through any combination of other devices. For example, a different wearable device may be used to obtain the data used to identify the user using the authenticator implemented at remote server 206, allowing a user to use a similar identification protocol with any number of devices. However, in other embodiments, the authenticator may be integrated with mobile device 204 or wearable device 202.

In one aspect, mobile device 204 may communicate the user's identification to the access control of any resource or location. In this embodiment, mobile device 204 is shown providing the user's authenticated identification to automated teller machine (ATM) 208, which may in turn grant the user access to perform financial transactions. In other embodiments, the identification system of this disclosure may be adapted to provide access or otherwise unlock anything that may be secured. This may include one or any number of resources, locations and objects such as a door, safe, vehicle, computer, network, application, website, or others.

As discussed above, data from one or more sensors may be used to identify a user, such as external sensor 108 and/or internal sensor 116 as described in reference to wearable device 100. One of skill in the art will appreciate that a wide variety of identifying information may be utilized depending on the sensor or sensors being employed. In one aspect, external sensor 108 and/or internal sensor 116 may be one or more motion sensors, including without limitation a gyroscope, an accelerometer or a magnetometer. Using sensor fusion techniques as described above, motion sensor data may be processed to provide an accurate orientation of device 100. Correspondingly, a sequence of orientations may be used to define a gesture or other suitable pattern of motion that may be characteristic of a user. Further exemplary details regarding suitable techniques for gesture recognition using motion sensors may be found in co-pending, commonly owned U.S. patent application Ser. No. 13/910,485, filed Jun. 5, 2013, which is hereby incorporated by reference in its entirety.

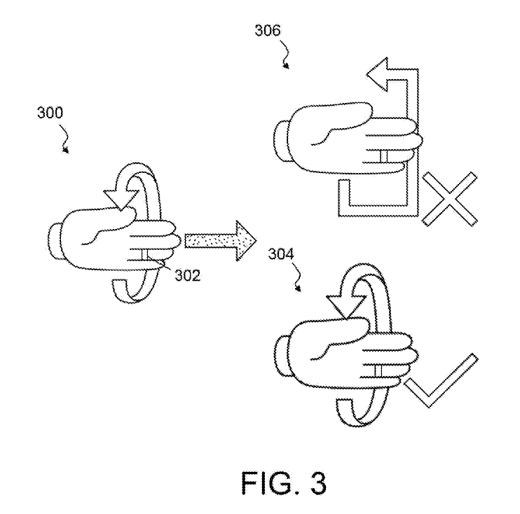

Accordingly, in one embodiment sensor data may be used to recognize a gesture in order to identify a user. As schematically represented in FIG. 3, a user may train a wearable device to recognize a specific gesture and subsequently to use that gesture to identify the user. In state 300, a user wearing a wearable device in the form of ring 302 may perform the specific gesture while ring 302 is in a learning mode. Correspondingly, the sensor data obtained while performing the specific gesture may be stored and associated with the user. Subsequently, the user may wish to authenticate identification in order to gain access to a controlled location or resource. As such, if the user performs the gesture correctly, such as within a suitable tolerance that may be selected depending on the level of security desired, an authenticator and an indicator associated with ring 302 (either within a self-contained device or as one or more separate devices) may verify the user as shown in state 304 and communicate information regarding the user's identification. Conversely, if the user does not perform the gesture correctly, the authenticator and indicator may report that the user was not identified as shown in state 306. Instead of using a learning mode, a predefined gesture may be used or a gesture that was characterized using a different set of sensors may be employed. Further, one gesture or a sequence of gestures may be used as desired.

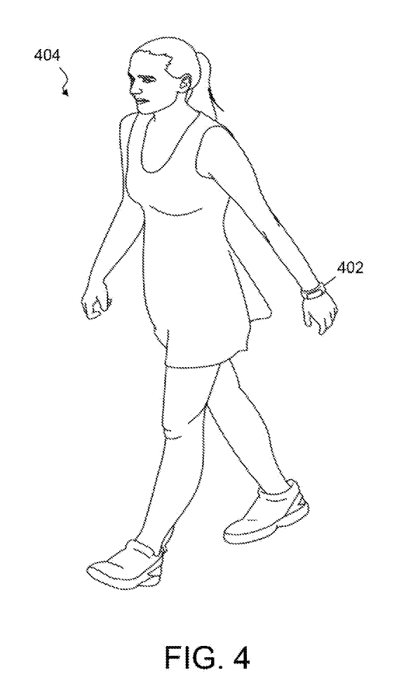

In another aspect, one or more motion sensors may be used to associate a detected pattern of motion that may be characteristic of the user. As shown in FIG. 4, wearable device 402 may be used to output data that corresponds to the gait of user 404 while walking. As will be appreciated, stride length, cadence and any other attributes that may be individual to a user may be used for identification. Again, it may be desirable to provide wearable device 402 with a learning mode during which identifying characteristics of user 404's walking pattern may be determined, such as by comparison to baseline reference.

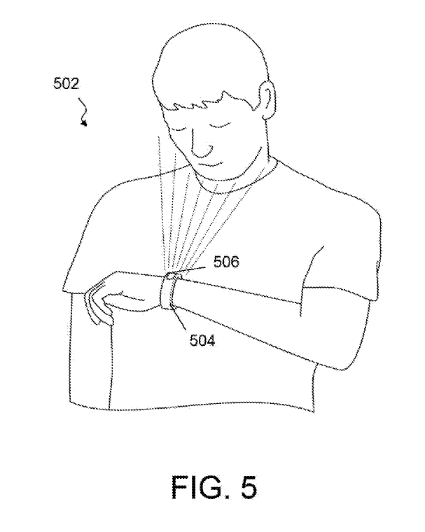

As will be appreciated, many other suitable techniques may be employed to use information from a sensor to identify a user. For example, FIG. 5 illustrates a user 502 wearing wearable device 504 having a camera sensor 506. In such an embodiment, data from camera sensor 506 may be used by an authenticator associated with wearable device 504 to perform a facial recognition algorithm to identify the user. A camera or other suitable optical sensor may also be used to recognize the pattern of a user's iris, fingerprint or any other distinguishing characteristic. In another aspect, a wearable device having a microphone may be used to record a user's voice in order to perform identification. As desired, identification using a user's voice may involve a speech recognition algorithm and a spoken password or phrase or may involve an audio analysis configured to recognize characteristics such as tone, pitch, timbre and the like. In still another aspect, a sensor configured to capture biometric information may be employed to recognize a physiological characteristic of the user. For example, a heart rate monitor sensor such as photoplethysmogram (PPG), electrocardiogram (ECG), and microphone may be used to recognize a heartbeat pattern characteristic of a user. In general, any sensor capable of obtaining data that may be associated with a personal characteristic of the user may be employed as desired.

Returning to FIG. 1, status monitor 118 may be configured to determine whether wearable device 100 is physically associated with the user. In one aspect, status monitor 118 may receive a signal representing a state of wearable device 100 that is indicative of whether it is being worn or is otherwise physically associated with the user. For example, FIG. 2 shows that wearable device 202 includes clasp 212 that may be opened when the user removes device 202 and may be closed when worn. Reporting the state of clasp 212 to status monitor 118 allows for the determination of whether device 202 has been worn continuously. Any other similar indication of the integrity of wearable device 100 when worn may be used as desired. In another aspect, status monitor 118 may process data from external sensor 108 and/or internal sensor 116 to determine whether device 100 is physically associated with the user. For example, appropriate sensors may be used to measure temperature, heart rate, or the like to determine whether wearable device 100 is being continuously worn.

Therefore, as described above, status monitor 118 may be used to determine whether wearable device 100 is physically associated with the user when external sensor 108 and/or internal sensor 116 obtains the data used to identify the user and further may be used to determine whether wearable device 100 has been continuously worn from the time that the data used to authenticate the user's identification was obtained. Under these conditions, indicator 122 may report any information regarding the identification of the user as being valid. If status monitor 118 determines that wearable device 100 is not physically associated with the user at any point after the data used for identification is obtained, indicator 122 may not report the identification as being valid and the user may be required to reauthenticate.

In the above embodiments, the indicator, such as indicator 122, may be used to confirm the authenticated identification of a user to any access control mechanism. Without limitation, this may include a secured application running on device 100 or may be any device, object, location or resource subject to access control that is external to the identification system. As noted above, this may include any use case that conventionally employs a physical key, such as a door, safe, vehicle, or the like, or a password, such as a computer, network, application, website, or the like. In one non-limiting example, the identification system of this disclosure may be used in conjunction with a point of sale technology, such as one that employs near field communications (NFC). Mobile devices such as smart phones may now be equipped with such communication abilities to facilitate financial transactions. By pairing these abilities with the identification system, the device would not be allowed to initiate a transaction without a valid current identification, thereby providing an additional layer of security. Similarly, the identification system techniques of this disclosure may be combined with other security protocols to provide enhanced protection.

In another aspect, the indicator may also provide information regarding the identification of a user directly to the user or to a third person. For example, in the embodiment shown in FIG. 2, mobile device 204 may also communicate that the user has been successfully identified using any suitable audible, visual or tactile notification, such as via display 210, thereby enabling the user or third person to determine whether an identification is currently valid or whether a reauthentication procedure is required.

In a further aspect, verification of a user's identification by authenticator 120 may also use information from location module 128 as desired. In this manner, a further layer of security may be achieved by verifying a user's identity dependent on the physical location of wearable device 100. For example, a bank employee may be granted access to the bank's computer network only when authenticator 120 determines the sensor information corresponds to the user's identification and when location module 128 reports that device 100 is on bank premises.

In yet another aspect, authenticator 120 may be configured to recognize multiple users, allowing the behavior of device 100 to be adjusted depending on which user is identified. As a representative example, different levels of access may be provided different users. This feature may also be extended beyond the context of controlling access, to allow device 100 to tailor applications and performance based on the user's identification. In one example, device 100 may provide a fitness tracking function and therefore may be able to properly correlate monitored activities to the respective users.

As desired, wearable device 100 may be configured to provide feedback to the user through indicator 122 regarding relative security levels. For example, authenticator 120 may be configured to evaluate the relative security strength of identification, such as the complexity of a gesture, so that the user may appreciate whether the identification is strong or weak and make the appropriate adjustments. Similarly, authenticator 120 may be configured to associate different levels of security to different sets of data from wearable device 100. In this manner, a relatively simple gesture may be used to grant access to rudimentary functions of wearable device 100 or to more general locations while a more complex gesture provides access to higher functions or more secure areas. Authenticator 120 may also be configured to guide the user during a learning mode of wearable device 100 to facilitate establishing a suitable gesture to be recognized or otherwise improve the ability of authenticator to associate data from wearable device 100 with a user's identification.

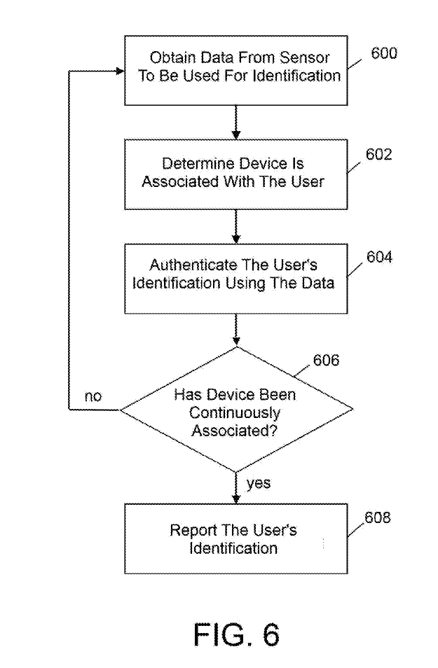

To help illustrate aspects of this disclosure with respect to device 100, FIG. 6 depicts a flowchart showing a process for identifying a user. Although described primarily in the context of a self-contained embodiment, such as shown in FIG. 1, it should be recognized that the relevant functions may be performed by any combination of devices as discussed above. Beginning with 600, device 100 may obtain sensor data from any suitable source, including internal sensor 116, external sensor 108 or a remote sensor using communications module 126. Further, the sensor data may be raw, subject to sensor fusion, or otherwise processed as desired. In 602, status monitor 118 determines whether the sensor data was obtained while device 100 was being worn or otherwise physically associated with a user. Next, authenticator 120 compares the sensor data to a stored profile associated with the user to verify the user's identification in 604. Upon verification of the identification by authenticator, indicator 122 may check status monitor 118 to determine whether device 100 has been physically associated with the user continuously since the sensor data used for identification was gathered in 606. If status monitor 118 reports device 100 has been continuously associated, the routine proceeds to 608 and indicator 122 may communicate information regarding the user's identification to any suitable recipient, including any internal or external access control process, the user, a third person, or other destination depending on the implementation. Alternatively, if status monitor 118 does not report that device 100 has been continuously worn, the routine may return to 600 so that the user may be reauthenticated. If desired, the number of times this routine may be performed without successful verification of the user's identification may be restricted or controlled to reduce the chances of unauthorized use.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A personal identification system comprising a wearable device, a status monitor, an authenticator and an indicator, wherein:
the wearable device includes at least one sensor and is configured to be physically associated with a user;
the status monitor is configured to determine that the wearable wearable device is physically associated with the user;
the authenticator is configured to identify the user based at least in part on data received from at least one sensor when the status monitor determines the wearable device is physically associated with the user; and
the indicator is configured to communicate identification information regarding the user.

2. The personal identification system of claim 1, wherein the wearable device is configured to be worn by the user.

3. The personal identification system of claim 1, wherein the indicator communicates identification information regarding the user in response to determining from the status monitor that the wearable device has been worn continuously since the user was identified.

4. The personal identification system of claim 1, wherein the indicator comprises at least one of a visual cue, an auditory cue and a tactile cue.

5. The personal identification system of claim 1, wherein the indicator communicates identification information regarding the user to an external device.

6. The personal identification system of claim 1, wherein the indicator communicates identification information regarding the user over a network.

7. The personal identification system of claim 1, wherein the authenticator is integrated into the wearable device.

8. The personal identification system of claim 1, wherein the indicator is integrated into the wearable device.

9. The personal identification system of claim 1, wherein the authenticator is implemented remotely.

10. The personal identification system of claim 1, wherein the at least one sensor is a camera and the authenticator identifies the user based at least in part on detecting a distinguishing feature of the user.

11. The personal identification system of claim 1, wherein the at least one sensor is a microphone and the authenticator identifies the user based at least in part on the user's voice.

12. The personal identification system of claim 1, wherein the at least one sensor is a heart rate sensor.

13. The personal identification system of claim 1, wherein the at least one sensor is a motion sensor

14. The personal identification system of claim 13, wherein the authenticator identifies the user based at least in part on detecting a gesture.

15. The personal identification system of claim 13, wherein the authenticator identifies the user based at least in part on detecting a pattern of motion associated with the user.

16. The personal identification system of claim 1, wherein the authenticator is configured to identify a plurality of users.

17. The personal identification system of claim 1, wherein the authenticator identifies the user based at least in part on a geographic location of the wearable device.

18. The personal identification system of claim 1, wherein the authenticator is configured to provide different levels of verification when identifying the user.

19. The personal identification system of claim 1, wherein the authenticator is configured to provide the user with a security evaluation regarding identification of the user.

20. A method for verifying the identity of a user comprising:
obtaining data from a wearable device having at least one sensor configured to be physically associated with the user;
monitoring whether the wearable device is physically associated with the user;
authenticating the user's identification based at least in part on the data if the data was obtained while the wearable device was physically associated with the user; and
communicating identification information regarding the user.

21. The method of claim 20, further comprising wearing the wearable device.

22. The method of claim 20, wherein identification information regarding the user is communicated after determining the wearable device has been continuously associated with the user since authentication of the user's identification.

23. The method of claim 20, wherein communicating identification information regarding the user comprises at least one of a visual cue, an auditory cue and a tactile cue.

24. The method of claim 20, further comprising communicating identification information regarding the user to an external device.

25. The method of claim 20, further comprising communicating identification information regarding the user over a network.

26. The method of claim 20, wherein the at least one sensor is a camera and authenticating the user's identification is based at least in part on detecting a distinguishing feature of the user.

27. The method of claim 20, wherein the at least one sensor is a microphone and authenticating the user's identification is based at least in part on the user's voice.

28. The method of claim 20, wherein authenticating the user's identification is based at least in part on detecting a gesture.

29. The method of claim 20, wherein authenticating the user's identification is based at least in part on detecting a pattern of motion associated with the user.

30. The method of claim 20, further comprising authenticating the identification of a plurality of users.

31. The method of claim 20, wherein authenticating the user's identification is based at least in part on a geographic location of the wearable device.

32. The method of claim 20, further comprising providing different levels of verification when authenticating the user's identification.

33. The method of claim 20, further comprising providing a security evaluation regarding the authentication of the user's identification.
